(19) United States
(12) Patent Application Publication
(10) Pub. No.: US 2026/0033933 A1
(43) Pub. Date: Feb. 5, 2026

(54) ORAL NURSING DEVICE AND CONTROL METHOD

(71) Applicant: Shenzhen Soocas Technology Co., Ltd., Shenzhen (CN)

(72) Inventors: Li GUO, Shenzhen (CN); Mingyu WANG, Shenzhen (CN); Fandi MENG, Shenzhen (CN)

(73) Assignee: Shenzhen Soocas Technology Co., Ltd., Shenzhen (CN)

(21) Appl. No.: 19/002,712

(22) Filed: Dec. 27, 2024

Related U.S. Application Data
(63) Continuation of application No. PCT/CN2024/133061, filed on Nov. 19, 2024.

(30) Foreign Application Priority Data
Aug. 2, 2024 (CN) 202411064914.4

(51) Int. Cl. A61C 17/34

(52) U.S. Cl. CPC A61C 17/3409

(57) ABSTRACT

Embodiments of the present application relate to the field of oral nursing technologies, and disclose an oral nursing device, a control method, an electronic device, and a storage medium, which can effectively improve a tooth cleaning effect. A control assembly can drive an output shaft of an actuation assembly to output a cleaning motion by outputting a driving signal, so as to drive a cleaning unit to vibrate at a high speed, thereby cleaning teeth. Meanwhile, in one cleaning motion, the output shaft rotates by a certain angle in a first direction or a second direction.

### CROSS-REFERENCE TO RELATED APPLICATIONS

The present application is a continuation of International Application No. PCT/CN2024/133061, filed on Nov. 19, 2024, which claims priority to Chinese Patent Application No. 202411064914.4, entitled “Oral Nursing Device, Control Method, Electronic Device, and Storage Medium”, filed with China National Intellectual Property Administration on Aug. 2, 2024, the entire content of which is incorporated herein by reference.

### TECHNICAL FIELD

The present application relates to the field of oral nursing technologies, and in particular, to an oral nursing device, a control method, an electronic device, and a storage medium.

### BACKGROUND

An electric toothbrush has the working principle that a brush head is driven to generate high-frequency vibrations by a motor, so as to enable bristles to vibrate at a high frequency on surfaces of teeth, such that toothpaste is decomposed into fine foam to deeply clean slits between the teeth, thereby realizing cleaning of the teeth.

In the related art, a control assembly in the electric toothbrush drives the motor with a driving signal having a fixed duty cycle, or the duty cycle of the driving signal is switched between two different duty cycles. Since the brush head of the electric toothbrush can only vibrate at the high frequency, the electric toothbrush has the technical problem of a poor tooth cleaning effect.

For the above problem, no effective solution is proposed at present.

### SUMMARY

In a first aspect, embodiments of the present application provide an oral nursing device, including: a cleaning portion at least provided with a cleaning unit; a grip portion connected with the cleaning portion; an actuation assembly at least partially accommodated in the grip portion, the actuation assembly including an output shaft engaged with the cleaning portion; and a control assembly generating a driving signal to drive the output shaft of the actuation assembly to output a cleaning motion and thus drive the cleaning unit, wherein the cleaning motion includes a first motion and a second motion, and as the first motion, the output shaft rotates by a first rotation angle along a first direction with a first axis as a rotation center line, and as the second motion, the output shaft rotates by a second rotation angle along a second direction with the first axis as the rotation center line, the first direction and the second direction are opposite, and the first rotation angle is different from the second rotation angle.

Optionally, the control assembly further generates the driving signal to drive the output shaft of the actuation assembly to output a periodic motion; the periodic motion includes at least a first half-cycle motion and/or a second half-cycle motion, and as the first half-cycle motion, the control assembly generates the driving signal to drive the output shaft to output one or more cleaning motions, such that the output shaft rotates by a first angle and then rotates back to an initial position with the first axis as the rotation center line; as the second half-cycle motion, the control assembly generates the driving signal to drive the output shaft to output one or more cleaning motions, such that the output shaft rotates by a second angle and then rotates back to the initial position with the first axis as the rotation center line; a direction of rotation of the output shaft by the first angle is different from a direction of rotation of the output shaft by the second angle.

Optionally, the control assembly determines a current direction of the actuation assembly to determine whether the output shaft outputs the first half-cycle motion or the second half-cycle motion.

Optionally, the control assembly periodically modifies the current direction of the actuation assembly to allow the output shaft to periodically switch output of the first half-cycle motion and the second half-cycle motion.

Optionally, the driving signal is a pulse width modulation signal, and the control assembly increases and decreases a duty cycle of the pulse width modulation signal according to a preset increment value, so as to allow the output shaft to output the first half-cycle motion.

Optionally, the control assembly increases the duty cycle of the pulse width modulation signal according to the preset increment value, and drives the output shaft to output a plurality of cleaning motions, such that the output shaft rotates by the first angle with the first axis as the rotation center line; the control assembly decreases the duty cycle of the pulse width modulation signal according to the preset increment value, and drives the output shaft to output a plurality of cleaning motions, such that the output shaft rotates back to the initial position with the first axis as the rotation central line.

Optionally, a rotation direction of the first half-cycle motion is the first direction, and the control assembly increases the duty cycle of the pulse width modulation signal according to the preset increment value, and drives the actuation assembly to output a plurality of cleaning motions with the first rotation angle greater than the second rotation angle, such that the output shaft rotates by the first angle with the first axis as the rotation center line; the control assembly decreases the duty cycle of the pulse width modulation signal according to the preset increment value, and drives the actuation assembly to output a plurality of cleaning motions with the second rotation angle greater than the first rotation angle, such that the output shaft rotates back to the initial position with the first axis as the rotation center line.

Optionally, the rotation direction of the first half-cycle motion is the second direction, and then, the control assembly increases the duty cycle of the pulse width modulation signal according to the preset increment value, and the second rotation angle is greater than the first rotation angle, such that the output shaft rotates by the first angle with the first axis as the rotation center line; the control assembly reduces the duty cycle of the pulse width modulation signal according to the preset increment value, and the first rotation angle is greater than the second rotation angle, such that the output shaft rotates back to the initial position with the first axis as the rotation center line.

Optionally, the control assembly further drives the actuation assembly to output a periodic vibration with a different rotation direction and a same rotation angle.

Optionally, the control assembly determines the first rotation angle and/or the second rotation angle according to user operations, sensed data and/or historical usage data.

Optionally, the control assembly determines the first angle and/or the second angle according to the user operations, the sensed data and/or the historical usage data.

Optionally, the control assembly determines the preset increment value and/or the duty cycle of the pulse width modulation signal according to the user operations, the sensed data and/or the historical usage data.

Optionally, the control assembly uses the driving signal to determine a frequency of the actuation assembly.

Optionally, the frequency of the actuation assembly is more than 100 Hz.

Optionally, the frequency of the actuation assembly ranges from 100 Hz to 300 Hz.

Optionally, the frequency of the actuation assembly is substantially constant.

Optionally, the first rotation angle and/or the second rotation angle ranges from 0.1 degrees to 1.5 degrees.

Optionally, the first rotation angle and/or the second rotation angle ranges from 0.3 degrees to 1.0 degree.

Optionally, the first angle and/or the second angle ranges from 6 degrees to 18 degrees.

Optionally, the first angle and/or the second angle ranges from 12 degrees to 15 degrees.

In a second aspect, embodiments of the present application further provide a control method of an oral nursing device, the oral nursing device including: a cleaning portion at least provided with a cleaning unit; a grip portion connected with the cleaning portion; an actuation assembly at least partially accommodated in the grip portion, the actuation assembly including an output shaft engaged with the cleaning portion; and a control assembly using a driving signal to drive the output shaft of the actuation assembly to output a periodic motion and thus drive the cleaning unit;
the control method of an oral nursing device including: by the control assembly, controlling a current direction of the actuation assembly to be a first current direction, and adjusting a duty cycle of the driving signal in a first increase-decrease mode, so as to allow the output shaft of the actuation assembly to output a first half-cycle motion; and by the control assembly, controlling the current direction of the actuation assembly to be a second current direction, and adjusting the duty cycle of the driving signal in a second increase-decrease mode, so as to allow the output shaft of the actuation assembly to output a second half-cycle motion, wherein the first current direction is different from the second current direction, and the periodic motion includes the first half-cycle motion and the second half-cycle motion.

Optionally, the control assembly periodically changes the current direction of the actuation assembly between the first current direction and the second current direction, such that the output shaft of the actuation assembly periodically outputs the first half-cycle motion and the second half-cycle motion.

Optionally, the adjusting a duty cycle of the driving signal in a first increase-decrease mode, so as to allow the output shaft of the actuation assembly to output a first half-cycle motion includes: increasing the duty cycle of the pulse width modulation signal according to a preset increment value, and driving the output shaft to output a plurality of cleaning motions, such that the output shaft rotates by a first angle with a first axis as a rotation center line; and decreasing the duty cycle of the pulse width modulation signal according to the preset increment value, and driving the output shaft to output a plurality of cleaning motions, such that the output shaft rotates back to an initial position with the first axis as the rotation center line; the cleaning motion includes a first motion and a second motion, and as the first motion, the output shaft rotates by a first rotation angle along a first direction with the first axis as the rotation center line, and as the second motion, the output shaft rotates by a second rotation angle along a second direction with the first axis as the rotation center line, the first direction and the second direction are opposite, and the first rotation angle is different from the second rotation angle.

Optionally, when the first rotation angle is larger than the second rotation angle, the cleaning motion is a first cleaning motion; when the second rotation angle is larger than the first rotation angle, the cleaning motion is a second cleaning motion.

Optionally, a rotation direction of the first half-cycle motion is the first direction; the increasing the duty cycle of the pulse width modulation signal according to a preset increment value, and driving the output shaft to output a plurality of cleaning motions, such that the output shaft rotates by a first angle with a first axis as a rotation center line includes: increasing the duty cycle of the pulse width modulation signal according to the preset increment value, and driving the output shaft to output a plurality of first cleaning motions, such that the output shaft rotates by the first angle with the first axis as the rotation center line;
the decreasing the duty cycle of the pulse width modulation signal according to the preset increment value, and driving the output shaft to output a plurality of cleaning motions, such that the output shaft rotates back to an initial position with the first axis as the rotation center line includes: decreasing the duty cycle of the pulse width modulation signal according to the preset increment value, and driving the output shaft to output a plurality of second cleaning motions, such that the output shaft rotates back to the initial position with the first axis as the rotation center line.

Optionally, the rotation direction of the first half-cycle motion is the second direction; the increasing the duty cycle of the pulse width modulation signal according to a preset increment value, and driving the output shaft to output a plurality of cleaning motions, such that the output shaft rotates by a first angle with a first axis as a rotation center line includes: increasing the duty cycle of the pulse width modulation signal according to the preset increment value, and driving the output shaft to output a plurality of second cleaning motions, such that the output shaft rotates by the first angle with the first axis as the rotation center line;
the decreasing the duty cycle of the pulse width modulation signal according to the preset increment value, and driving the output shaft to output a plurality of cleaning motions, such that the output shaft rotates back to an initial position with the first axis as the rotation center line includes: decreasing the duty cycle of the pulse width modulation signal according to the preset increment value, and driving the output shaft to output a plurality of first cleaning motions, such that the output shaft rotates back to the initial position with the first axis as the rotation center line.

Optionally, the frequency of the actuation assembly is more than 100 Hz.

Optionally, the frequency of the actuation assembly ranges from 100 Hz to 300 Hz.

Optionally, the frequency of the actuation assembly is substantially constant.

Optionally, the first rotation angle and/or the second rotation angle ranges from 0.1 degrees to 1.5 degrees.

Optionally, the first rotation angle and/or the second rotation angle ranges from 0.3 degrees to 1.0 degree.

Optionally, the first angle and/or the second angle ranges from 6 degrees to 18 degrees.

Optionally, the first angle and/or the second angle ranges from 12 degrees to 15 degrees.

In a third aspect, embodiments of the present application further provide an electronic device, including a processor and a memory storing program instructions, the processor being configured to, when executing the program instructions, perform the control method of an oral nursing device according to any one of the embodiments of the present application.

In a fourth aspect, embodiments of the present application further provide a storage medium storing program instructions, the program instructions, when executed, performing the control method of an oral nursing device according to any one of the embodiments of the present application.

### BRIEF DESCRIPTION OF THE DRAWINGS

To describe the technical solutions of the embodiments of the present application or the prior art more clearly, the following briefly describes the accompanying drawings required for describing the embodiments or the prior art. Apparently, the accompanying drawings in the following description only show some embodiments of the present application, and a person of ordinary skill in the art may still derive other drawings from these accompanying drawings without creative efforts.

FIG. 1 is a schematic structural diagram of an oral nursing device according to an embodiment of the present application;

FIG. 2 is a schematic flow diagram of a control method of an oral nursing device according to an embodiment of the present application; and

FIG. 3 is a schematic structural diagram of an electronic device according to an embodiment of the present application.

### DETAILED DESCRIPTION

Embodiments of the present application provide an oral nursing device, a control method, an electronic device, and a storage medium, which can effectively improve a tooth cleaning effect.

In the oral nursing device according to the embodiment of the present application, the control assembly can drive the output shaft of the actuation assembly to output the cleaning motion by outputting the driving signal, so as to drive the cleaning unit to vibrate at a high speed, thereby cleaning teeth. Meanwhile, in one cleaning motion, the output shaft rotates by a certain angle in the first direction or the second direction. Under the condition that the output shaft outputs a plurality of cleaning motions, the cleaning unit produces a sweeping effect, such that the action that a human hand swings a brush head to clean the teeth can be imitated to clean the oral cavity more thoroughly and deeply, thus improving the tooth cleaning effect.

For convenience of description, some nouns or terms involved in the embodiments of the present application are explained below:

Duty Cycle: a ratio of the time when a signal is in a high level state in one cycle to the total cycle. In motor control, the duty cycle may be used to control a working mode and power output of a motor. The motor control is realized by using a pulse width modulation (PWM) technology. In the PWM technology, an output voltage is controlled by varying the duty cycle of a pulse, thereby controlling a working state of the motor. In general, the larger the duty cycle is, the larger the power output by the motor is, and a rotation angle of an output shaft of the motor is correspondingly increased; conversely, the smaller the duty cycle is, the smaller the power output by the motor is, and the rotation angle of the output shaft of the motor is correspondingly reduced.

In the related art, in an electric toothbrush, a brush head generates high-frequency vibrations to decompose toothpaste into fine foam, so as to deeply clean slits between teeth, thereby realizing cleaning of the teeth. However, the method has a small cleaning area, and thus has a poor tooth cleaning effect.

In view of this, the embodiments of the present application provide an oral nursing device, a control method, an electronic device, and a storage medium; during an operation process of the oral nursing device, the brush head sweeps while vibrating at a high frequency, so as to clean the oral cavity more thoroughly and deeply, thus improving the tooth cleaning effect.

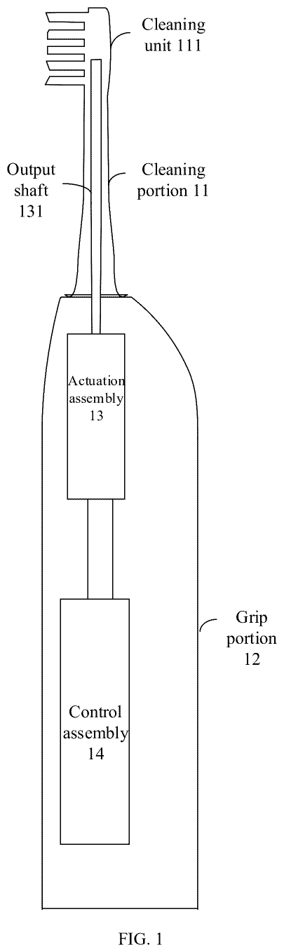

The embodiments of the present application provide an oral nursing device for cleaning the teeth. Specifically, as shown in FIG. 1, the oral nursing device may include a cleaning portion 11, a grip portion 12, an actuation assembly 13, and a control assembly 14.

The cleaning portion 11 is detachably or fixedly connected with the grip portion 12. When the oral nursing device is used, a user holds the grip portion 12, puts the cleaning portion 11 connected with the grip portion 12 into the oral cavity, and cleans or nurses the oral cavity or teeth with the cleaning portion 11.

Since the cleaning portion 11 frequently contacts the teeth during the process of cleaning or nursing the teeth, the cleaning portion 11 is worn or abraded more seriously than the grip portion 12 during a use process, and is required to be replaced in time. When the cleaning portion 11 is detachably connected with the grip portion 12, the user can more conveniently replace the cleaning portion 11 when the cleaning portion is required to be replaced, thereby improving use experience of the user.

The control assembly 14 and the actuation assembly 13 may be arranged inside the grip portion 12. The actuation assembly 13 may include an output shaft 131, and the output shaft 131 may be connected with the cleaning portion 11. The cleaning portion 11 may include a cleaning unit 111, and the cleaning unit 111 may be specifically a toothbrush head. Specifically, the output shaft 131 may be connected with the cleaning unit 111.

The control assembly 14 may be electrically connected with the actuation assembly 13, and the control assembly 14 may output a driving signal to the actuation assembly 13 through a connection wire therebetween. Specifically, the actuation assembly 13 may include a driving chip. The driving chip can receive the driving signal output by the control assembly 14, and drive the output shaft of the actuation assembly 13 to output a cleaning motion after performing power amplification on the driving signal. Thus, the cleaning unit 111 can be driven by the output shaft to move to achieve the tooth cleaning effect.

It should be noted that, as shown in FIG. 1, the positional relationship between the control assembly 14 and the actuation assembly 13 inside the grip portion 12 is only exemplary, and the positional relationship between components inside the grip portion 12 can be adjusted, which is not limited in the embodiment of the present application.

Specifically, the control assembly 14 is configured to control operation of the whole oral nursing device, and may be a microcontroller unit (MCU), or a central process unit (CPU) of the oral nursing device. The actuation assembly 13 may be a motor, such as a sonic motor, or the like, and the output shaft 131 is a motor shaft of the motor. As an implementation, an open-loop control manner is adopted in the embodiment of the present application, the control assembly 14 implements output control over the output shaft 131 of the actuation assembly 13 by adjusting the driving signal, including but not limited to a current direction of the actuation assembly 13, a duty cycle of a pulse width modulation signal, or the like, sweeping and vibration cleaning can be realized without acquiring a real-time position of the output shaft 131, the control method is simpler and more convenient, and a sensor for detecting the position of the output shaft 131 is avoided, thus reducing a production cost, avoiding interference of sensor failure or error data, and guaranteeing operation stability and accuracy.

An implementation of output of the cleaning motion by the output shaft 131 of the actuation assembly 13 is described below.

First, the output shaft 131 rotates by a first rotation angle in a first direction with a first axis as a rotation center line, and then, the output shaft 131 rotates by a second rotation angle in a second direction with the first axis as the rotation center line. The first direction and the second direction are opposite directions. Specifically, the first axis may be a center line of the output shaft 131.

In an example, the first direction is clockwise and the second direction is counterclockwise. In another example, the first direction is counterclockwise and the second direction is clockwise.

When the output shaft 131 periodically outputs the cleaning motion, the cleaning unit 111 generates high-frequency vibrations, thereby achieving the tooth cleaning effect.

Meanwhile, the first rotation angle may be larger or smaller than the second rotation angle. For convenience of description, when the first rotation angle of a first motion is greater than the second rotation angle of a second motion, the cleaning motion may be referred to as a first cleaning motion. When the first rotation angle of the first motion is smaller than the second rotation angle of the second motion, the cleaning motion may be referred to as a second cleaning motion.

In one first cleaning motion, the output shaft 131 rotates in the first direction by an angle which is a difference between the first rotation angle and the second rotation angle. For example, if the first direction is clockwise, the first rotation angle is 1 degree, and the second rotation angle is 0.6 degrees, in one first cleaning motion, the output shaft 131 first rotates by 1 degree clockwise and then rotates by 0.6 degrees counterclockwise, thus achieving the overall effect that the output shaft 131 rotates by 0.4 degrees clockwise.

When outputting a plurality of first cleaning motions, the output shaft 131 may rotate by a large angle in the first direction to generate an effect of sweeping in the first direction, and may swing the cleaning unit 111 in the first direction with the first axis as a rotation center in imitation of a human hand, thereby expanding a tooth cleaning range.

Similarly, in one second cleaning motion, the output shaft 131 rotates in the second direction by an angle which is a difference between the second rotation angle and the first rotation angle. When outputting a plurality of second cleaning motions, the output shaft 131 may rotate by a large angle in the second direction to generate an effect of sweeping in the second direction, and may swing the cleaning unit 111 in the second direction with the first axis as the rotation center in imitation of the human hand, thereby expanding the tooth cleaning range.

Thus, the cleaning unit 111 can generate the sweeping effect in addition to the high-speed vibration to clean the teeth more thoroughly and deeply, thereby improving the tooth cleaning effect.

In the embodiment of the present application, the control assembly 14 can drive the output shaft 131 of the actuation assembly 13 to output the cleaning motion by outputting the driving signal, so as to drive the cleaning unit 111 to perform the corresponding motion. As one cleaning motion, the output shaft 131 rotates by the first rotation angle in the first direction with the first axis as the rotation center, and then rotates by the second rotation angle in the second direction opposite to the first direction with the first axis as the rotation center. When the output shaft 131 outputs a plurality of cleaning motions, the cleaning unit 111 generates the high-speed vibration to clean the teeth.

Meanwhile, in one cleaning motion, the output shaft 131 rotates by a certain angle (specifically, the difference between the first rotation angle and the second rotation angle) in the first direction, or rotates by a certain angle (specifically, the difference between the second rotation angle and the first rotation angle) in the second direction. Under the condition that the output shaft 131 outputs a plurality of cleaning motions, the cleaning unit 111 produces the sweeping effect, such that the action that the human hand swings a brush head to clean the teeth can be imitated to perform reciprocating sweeping cleaning on the same tooth region, so as to clean the oral cavity more thoroughly and deeply, thus improving the tooth cleaning effect.

Optionally, in some embodiments of the present application, the control assembly 14 may further generate the driving signal to drive the output shaft 131 of the actuation assembly 13 to output a periodic motion. The periodic motion includes at least a first half-cycle motion and/or a second half-cycle motion, and as the first half-cycle motion, the control assembly 14 generates the driving signal to drive the output shaft 131 to output one or more cleaning motions, such that the output shaft 131 rotates by a first angle and then rotates back to an initial position with the first axis as the rotation center line; as the second half-cycle motion, the control assembly 14 generates the driving signal to drive the output shaft 131 to output one or more cleaning motions, such that the output shaft 131 rotates by a second angle and then rotates back to the initial position with the first axis as the rotation center line; a direction of rotation of the output shaft 131 by the first angle is different from a direction of rotation of the output shaft 131 by the second angle.

In the embodiment of the present application, the control assembly 14 may use the driving signal to drive the output shaft 131 of the actuation assembly 13 to output the periodic motion. When continuously outputting a plurality of periodic motions, the output shaft 131 can drive the cleaning unit 111 to generate a continuous sweeping effect.

Each periodic motion may include one first half-cycle motion and one second half-cycle motion. The maximum angle corresponding to the first half-cycle motion is the first angle, and the maximum angle corresponding to the second half-cycle motion is the second angle. The direction of rotation of the output shaft 131 by the first angle is different from the direction of rotation of the output shaft 131 by the second angle.

In an example, a direction of the first half-cycle motion is the first direction, and a direction of the second half-cycle motion is the second direction. In the first half-cycle motion, the output shaft 131 outputs a plurality of first cleaning motions, and by adding the angular differences generated by the plurality of first cleaning motions, the output shaft 131 can rotate by the first angle in the first direction with the first axis as the rotation center line. Then, the output shaft 131 may further output a plurality of second cleaning motions, and by adding the angular differences generated by the plurality of second cleaning motions, the output shaft 131 may rotate from the first angle to the initial position in the second direction with the first axis as the rotation center line.

Similarly, in the second half-cycle motion, the output shaft 131 outputs a plurality of second cleaning motions, and by adding the angular differences generated by the plurality of second cleaning motions, the output shaft 131 can rotate by the second angle from the initial position along the second direction with the first axis as the rotation center line. Then, the output shaft 131 may further output a plurality of first cleaning motions, and by adding the angular differences generated by the plurality of first cleaning motions, the output shaft 131 may rotate from the second angle to the initial position in the first direction with the first axis as the rotation center line.

The initial position may be a zero point position, or a position corresponding to any rotation angle of 0 to 360 degrees relative to the zero point position with the first axis as the rotation center line, which is not limited in the embodiment of the present application.

The direction of rotation of the output shaft 131 by the first angle and the direction of rotation of the output shaft 131 by the second angle are located on two sides of the initial position respectively, and are opposite. Exemplarily, an angle realized by rotating by 10 degrees clockwise from the initial position is the first angle, and an angle realized by rotating by 10 degrees counterclockwise from the initial position is the second angle.

It may be understood that when the rotation direction of the first half-cycle motion is the second direction and the rotation direction of the second half-cycle motion is the first direction, an implementation thereof is similar to that in the above description, and is not repeated herein. Thus, in the same periodic motion, the output shaft 131 outputs a plurality of cleaning motions, the cleaning motions serve as unit motions to form the periodic motion, and compared with a conventional electric toothbrush cleaning mode in which the brush head can only perform one time of reciprocating cleaning in one periodic motion, in the embodiment of the present application, the cleaning unit 111 can perform multiple times of sweeping on the same position in one periodic motion to imitate the action that the human hand swings the brush head to clean the tooth, but a cleaning time number and a cleaning speed are much higher than those of manual cleaning, such that the oral cavity can be more thoroughly and deeply cleaned through one or more periodic motions, and especially for positions difficult to clean, such as tooth slits, or the like, and positions required to be deeply cleaned, such as occlusal surfaces, or the like, a better cleaning effect can be achieved without applying an excessively large force, and oral tissue, such as gums, or the like, of the user can be protected from being injured.

Optionally, in some embodiments of the present application, the control assembly 14 determines a current direction of the actuation assembly 13 to determine whether the output shaft 131 outputs the first half-cycle motion or the second half-cycle motion.

In the embodiment of the present application, since the rotation direction of the output shaft 131 is related to the direction of a current flowing through the actuation assembly 13, the control assembly 14 can determine whether the output shaft 131 outputs the first half-cycle motion or the second half-cycle motion by controlling the direction of the current flowing through the actuation assembly 13.

Exemplarily, the direction of the first half-cycle motion may be clockwise and the direction of the second half-cycle motion may be counterclockwise. The actuation assembly 13 may be a motor including a positive pole and a negative pole. The control assembly 14 may cause the output shaft 131 to output the first half-cycle motion by controlling the current of the motor to flow from the positive pole to the negative pole. The output shaft 131 can output the second half-cycle motion by controlling the current of the motor to flow from the negative pole to the positive pole.

Optionally, in some embodiments of the present application, the control assembly 14 periodically modifies the current direction of the actuation assembly 13 to allow the output shaft 131 to periodically switch output of the first half-cycle motion and the second half-cycle motion.

In the embodiment of the present application, the control assembly 14 can control the output shaft 131 to output the first half-cycle motion or the second half-cycle motion by changing the current direction of the actuation assembly 13. Therefore, the control assembly 14 modifies the current direction of the actuation assembly 13 according to a preset period, such that the output shaft 131 can switch the output of the first half-cycle motion and the second half-cycle motion according to the preset period, so as to drive the cleaning unit 111 to generate the continuous sweeping effect.

It may be understood that the user can set a duration of the preset period according to actual needs, such that the sweeping speed of the cleaning unit 111 can be adjusted.

Optionally, in some embodiments of the present application, the driving signal is a pulse width modulation signal, and the control assembly 14 increases and decreases the duty cycle of the pulse width modulation signal according to a preset increment value, so as to allow the output shaft 131 to output the first half-cycle motion.

In the embodiment of the present application, the driving signal may be a pulse width modulation signal. The control assembly 14 may continuously increase the duty cycle of the pulse width modulation signal according to the preset increment value, such that the output shaft 131 rotates by the first angle with the first axis as the rotation center line. Then, the control assembly 14 continuously decreases the duty cycle of the pulse width modulation signal, such that the output shaft 131 rotates from the first angle to the initial position with the first axis as the rotation center line. When the duty cycle of the pulse width modulation signal reaches a minimum value, the control assembly 14 modifies the current direction of the actuation assembly 13, such that the next half-cycle motion begins.

It should be noted that the preset increment value may be a fixed value, and at this point, the control assembly 14 may increase the duty cycle of the pulse width modulation signal at a uniform speed. In a specific example, the control assembly 14 increases the duty cycle of the pulse width modulation signal at a period of 5 ms. For example, at Oms, the duty cycle of the pulse width modulation signal output by the control assembly 14 is 10%. At 5 ms, the duty cycle of the pulse width modulation signal output by the control assembly 14 is 11%. At 10 ms, the duty cycle of the pulse width modulation signal output by the control assembly 14 is 12%. At 15 ms, the duty cycle of the pulse width modulation signal output by the control assembly 14 is 13%, and so on.

Furthermore, the preset increment value may also be a variable, and at this point, the control assembly 14 may increase the duty cycle of the pulse width modulation signal at a variable speed, and the manner in which the control assembly 14 adjusts the duty cycle of the pulse width modulation signal is not limited in the embodiment of the present application.

Optionally, in some embodiments of the present application, the control assembly 14 increases the duty cycle of the pulse width modulation signal according to the preset increment value, and drives the output shaft 131 to output a plurality of cleaning motions, such that the output shaft 131 rotates by the first angle with the first axis as the rotation center line; the control assembly 14 decreases the duty cycle of the pulse width modulation signal according to the preset increment value, and drives the output shaft 131 to output a plurality of cleaning motions, such that the output shaft 131 rotates back to the initial position with the first axis as the rotation central line.

In the embodiment of the present application, by increasing the duty cycle of the pulse width modulation signal once according to the preset increment value, the control assembly 14 can drive the output shaft 131 to output one cleaning motion which may be the first cleaning motion or the second cleaning motion.

The control assembly 14 may drive the output shaft 131 to output a plurality of cleaning motions by increasing the duty cycle of the pulse width modulation signal a plurality of times, and by adding the angular differences generated by the plurality of cleaning motions, the output shaft 131 can rotate by the first angle with the first axis as the rotation center line.

Similarly, the control assembly 14 may drive the output shaft 131 to output one cleaning motion by reducing the duty cycle of the pulse width modulation signal once according to the preset increment value, the cleaning motion has a different type from the foregoing cleaning motion, and the cleaning motion is the second cleaning motion when the foregoing cleaning motion is the first cleaning motion. When the foregoing cleaning motion is the second cleaning motion, the cleaning motion is the first cleaning motion.

The control assembly 14 may drive the output shaft 131 to output a plurality of cleaning motions by reducing the duty cycle of the pulse width modulation signal a plurality of times. By adding the angular differences generated by the plurality of cleaning motions, the output shaft 131 can rotate from the first angle to the initial position with the first axis as the rotation center line, thereby completing the first half-cycle motion.

Optionally, in some embodiments of the present application, the rotation direction of the first half-cycle motion is the first direction, and the control assembly 14 increases the duty cycle of the pulse width modulation signal according to the preset increment value, and drives the actuation assembly 13 to output a plurality of cleaning motions with the first rotation angle greater than the second rotation angle, such that the output shaft 131 rotates by the first angle with the first axis as the rotation center line; the control assembly 14 decreases the duty cycle of the pulse width modulation signal according to the preset increment value, and drives the actuation assembly 13 to output a plurality of cleaning motions with the second rotation angle greater than the first rotation angle, such that the output shaft 131 rotates back to the initial position with the first axis as the rotation center line.

In the embodiment of the present application, the rotation direction of the first half-cycle motion may be the first direction. The control assembly 14 may drive the output shaft 131 to output one first cleaning motion by increasing the duty cycle of the pulse width modulation signal once according to the preset increment value. Therefore, by increasing the duty cycle of the pulse width modulation signal multiple times, the output shaft 131 can be driven to output multiple first cleaning motions, and the output shaft 131 is driven to rotate by the first angle along the first direction with the first axis as the rotation center line. Exemplarily, if the first angle is 8 degrees, and the difference between the first rotation angle and the second rotation angle in the first cleaning motion is 0.4 degrees, the control assembly 14 increases the duty cycle 20 times, and drives the output shaft 131 to output 20 cleaning motions, and then, the output shaft 131 can rotate by the first angle.

Similarly, the control assembly 14 may drive the output shaft 131 to output one second cleaning motion by decreasing the duty cycle of the pulse width modulation signal once according to the preset increment value. Therefore, by decreasing the duty cycle of the pulse width modulation signal multiple times, the output shaft 131 can be driven to output multiple second cleaning motions, and the output shaft 131 is driven to rotate from the first angle to the initial position with the first axis as the rotation center line. Exemplarily, if the first angle is 8 degrees, and the difference between the second rotation angle and the first rotation angle in the second cleaning motion is 0.4 degrees, the control assembly 14 decreases the duty cycle 20 times, and drives the output shaft 131 to output 20 cleaning motions, and then, the output shaft 131 can rotate from the first angle to the initial position.

It may be understood that the first direction may be clockwise or counterclockwise. In the second half-cycle motion, the output shaft 131 can rotate by the second angle and rotate back to the initial position in the same manner, which is not repeated herein.

Optionally, in some embodiments of the present application, the rotation direction of the first half-cycle motion is the second direction, and then, the control assembly 14 increases the duty cycle of the pulse width modulation signal according to the preset increment value, and the second rotation angle is greater than the first rotation angle, such that the output shaft 131 rotates by the first angle with the first axis as the rotation center line; the control assembly 14 reduces the duty cycle of the pulse width modulation signal according to the preset increment value, and the first rotation angle is greater than the second rotation angle, such that the output shaft 131 rotates back to the initial position with the first axis as the rotation center line.

In the embodiment of the present application, the rotation direction of the first half-cycle motion may be the second direction.

The control assembly 14 may drive the output shaft 131 to output one second cleaning motion by increasing the duty cycle of the pulse width modulation signal once according to the preset increment value. Therefore, by increasing the duty cycle of the pulse width modulation signal multiple times, the output shaft 131 can be driven to output multiple second cleaning motions, and by adding the angular differences generated by the multiple second cleaning motions, the output shaft 131 can rotate by the first angle along the second direction with the first axis as the rotation center line. Exemplarily, if the first angle is 10 degrees, and the difference between the second rotation angle and the first rotation angle in the second cleaning motion is 0.4 degrees, the control assembly 14 increases the duty cycle 25 times, and drives the output shaft 131 to output 25 second cleaning motions, and then, the output shaft 131 can rotate by the first angle.

Similarly, the control assembly 14 may drive the output shaft 131 to output one first cleaning motion by decreasing the duty cycle of the pulse width modulation signal once according to the preset increment value. Thus, by reducing the duty cycle of the pulse width modulation signal a plurality of times, the output shaft 131 can be driven to output a plurality of first cleaning motions. By adding the angular differences generated by the plurality of first cleaning motions, the output shaft 131 can rotate from the first angle to the initial position with the first axis as the rotation center line. Exemplarily, if the first angle is 10 degrees, and the difference between the first rotation angle and the second rotation angle in the first cleaning motion is 0.4 degrees, the control assembly 14 decreases the duty cycle 25 times, and drives the output shaft 131 to output 25 second cleaning motions, and then, the output shaft 131 can rotate from the first angle to the initial position with the first axis as the rotation center line.

It may be understood that in the second half-cycle motion, the output shaft 131 can rotate by the second angle and rotate back to the initial position in the same manner, which is not repeated herein.

Optionally, in some embodiments of the present application, the control assembly 14 further drives the actuation assembly 13 to output a periodic vibration with a different rotation direction and a same rotation angle.

In the embodiment of the present application, for convenience of description, the cleaning motion having a different rotation direction and a same rotation angle may be referred to as a third cleaning motion. The control assembly 14 can also drive the actuation assembly 13 to output the third cleaning motion, such that the cleaning unit 111 performs the high-frequency vibration to clean the teeth with a fixed position as a center. The control assembly 14 can drive the output shaft 131 of the actuation assembly 13 to output the first cleaning motion and the third cleaning motion in a mixed mode by controlling the driving signal, so as to improve the tooth cleaning effect.

Exemplarily, the control assembly 14 may drive the output shaft 131 to output one first cleaning motion, then output one third cleaning motion, and then output one first cleaning motion and one third cleaning motion, such that the first cleaning motion and the third cleaning motion can be output in an alternatively mixed mode.

Certainly, the above is only exemplary illustration, and the control assembly 14 may drive the output shaft 131 to output M first cleaning motions and then output N third cleaning motions, such that the first and third cleaning motions are periodically output in the alternatively mixed mode. Values of M and N can be determined according to actual needs. Similarly, the control assembly 14 can also drive the output shaft 131 to output the second cleaning motion and the third cleaning motion in a mixed mode.

Optionally, in some embodiments of the present application, the control assembly 14 determines the first rotation angle and/or the second rotation angle according to user operations, sensed data and/or historical usage data.

In the embodiment of the present application, the control assembly 14 may determine the first rotation angle and/or the second rotation angle according to the user operation. Specifically, the oral nursing device may be provided with a plurality of keys for selecting the first rotation angle and the second rotation angle, and the user may generate different control signals by selecting different keys, so as to control the first rotation angle and/or the second rotation angle.

Furthermore, a sensor, such as a gyroscope, may be provided in the oral nursing device. The sensor may be configured to detect a type of a user action and the control assembly 14 may control the first and/or second rotation angle according to the type of the action.

Different users have different habits and requirements for using the oral nursing device, and the control assembly 14 can determine the first rotation angle and/or the second rotation angle based on the historical usage data, such as habit data of the users for using the oral nursing device or user-defined setting data, and can further adjust the difference between the first rotation angle and the second rotation angle, so as to adjust a sweeping range, speed and/or force to make the sweeping range, speed and/or force better satisfy individual habits of the users, thereby further improving use experience of the users.

Optionally, in some embodiments of the present application, the control assembly 14 determines the first angle and/or the second angle according to the user operations, the sensed data and/or the historical usage data.

In the embodiment of the present application, the control assembly 14 may determine the first angle and/or the second angle according to the user operation. Specifically, the oral nursing device may be provided with a plurality of keys for selecting the first angle and the second angle, and the user may generate different control signals by selecting different keys, so as to control the first angle and/or the second angle.

Specifically, if the user prefers to clean the teeth at a large angle, the first angle and the second angle may be set to a large value. If the user prefers to clean the teeth at a small angle, the first angle and the second angle may be set to a small value.

Furthermore, a sensor, such as a gyroscope, may be provided in the oral nursing device. When a different action of the user is detected, the first angle and/or the second angle may be determined according to a type of the action.

Different users have different habits and requirements for using the oral nursing device, and the control assembly 14 can determine the first angle and/or the second angle based on the historical usage data, such as habit data of the users for using the oral nursing device or user-defined setting data, so as to make the first angle and the second angle better satisfy individual habits of the users, thereby further improving use experience of the users.

Optionally, in some embodiments of the present application, the control assembly 14 determines the preset increment value and/or the duty cycle of the pulse width modulation signal according to the user operations, the sensed data and/or the historical usage data.

In the embodiment of the present application, the control assembly 14 may determine the preset increment value and/or the duty cycle of the pulse width modulation signal according to the user operation. Specifically, the oral nursing device may be provided with a plurality of keys for selecting the preset increment value, and the user may generate different control signals by selecting different keys, so as to control the preset increment value. The larger the preset incremental value is, the faster the sweeping speed of the cleaning unit 111 is.

Similarly, the control assembly 14 may control the duty cycle of the pulse width modulation signal in the same manner.

Furthermore, a sensor, such as a gyroscope, may be provided in the oral nursing device. When a different action of the user is detected, the preset increment value and/or the duty cycle of the pulse width modulation signal can be determined according to a type of the action.

Different users have different habits and requirements for using the oral nursing device, and the control assembly 14 can determine the preset increment value and/or the duty cycle of the pulse width modulation signal based on the historical usage data, such as habit data of the users for using the oral nursing device or user-defined setting data, so as to make the preset increment value and/or the duty cycle of the pulse width modulation signal better satisfy individual habits of the users, thereby further improving use experience of the users.

Optionally, in some embodiments of the present application, the control assembly 14 uses the driving signal to determine a frequency of the actuation assembly 13.

In the embodiment of the present application, since the frequency of the actuation assembly 13 is equal to the frequency of the driving signal sent by the control assembly 14, the control assembly 14 can determine the frequency of the actuation assembly 13 by controlling the frequency of the driving signal. For example, when the control assembly 14 outputs the driving signal with a frequency of 200 Hz, the frequency of the actuation assembly 13 may be 200 Hz. Since the first angle and the second angle are related to the frequency of the actuation assembly 13, the control assembly 14 can control the first angle and the second angle by controlling the frequency of the driving signal.

Optionally, in some embodiments of the present application, the frequency of the actuation assembly 13 is more than 100 Hz.

In the embodiment of the present application, since the frequency of the actuation assembly 13 is related to a swing angle (i.e., the first angle and the second angle) of the output shaft 131 of the actuation assembly 13, the swing angle of the output shaft 131 can be changed by changing the frequency of the actuation assembly 13. In order to control the swing angle of the output shaft 131 within a reasonable range, the frequency of the actuation assembly 13 may be controlled to be more than 100 Hz.

Exemplarily, when the frequency of the actuation assembly 13 is more than 100 Hz, the swing angle of the output shaft 131 of the actuation assembly 13 is greater than 3 degrees, such that the swing angle is within the reasonable range and is not excessively small, such that the teeth can be cleaned more effectively.

Optionally, in some embodiments of the present application, the frequency of the actuation assembly 13 ranges from 100 Hz to 300 Hz.

In the embodiment of the present application, in order to better control the swing angle of the output shaft 131, and avoid or reduce a force load applied by the user/teeth on the cleaning unit which results in weakening of power of the actuation assembly 13 to cause the swing angle to be excessively small, the control assembly 14 may control the frequency of the driving signal within the range of 100 Hz to 300 Hz, such that the frequency of the actuation assembly 13 is within the range of 100 Hz to 300 Hz, and then, the swing angle of the output shaft 131 is within the reasonable range. Therefore, an injury to the gum when the swing angle is excessively large may be avoided, and a poor tooth cleaning effect when the swing angle is excessively small can also be avoided.

Optionally, in some embodiments of the present application, the frequency of the actuation assembly 13 is substantially constant.

In the embodiment of the present application, the control assembly 14 may output the driving signal with a substantially constant frequency, such that the frequency of the actuation assembly 13 is also substantially constant, and further, the swing angle of the output shaft 131 is also substantially constant, which may improve the use experience of the user.

Optionally, in some embodiments of the present application, the first rotation angle and/or the second rotation angle ranges from 0.1 degrees to 1.5 degrees.

In the embodiment of the present application, the first rotation angle and the second rotation angle can be in a reasonable range by controlling the first rotation angle and the second rotation angle to range from 0.1 degrees to 1.5 degrees, and the teeth can be cleaned effectively. Meanwhile, the maximum difference between the first rotation angle and the second rotation angle is 1.4 degrees, thus avoiding that the difference between the first rotation angle and the second rotation angle is excessively large, the sweeping speed of the output shaft 131 is excessively high, and the teeth cannot be effectively cleaned.

Optionally, in some embodiments of the present application, the first rotation angle and/or the second rotation angle ranges from 0.3 degrees to 1.0 degree.

In the embodiment of the present application, the first rotation angle and the second rotation angle can be in a reasonable range by controlling the first rotation angle and the second rotation angle to range from 0.3 degrees to 1.0 degree; the maximum difference between the first rotation angle and the second rotation angle is 0.7 degrees, thus avoiding that the difference between the first rotation angle and the second rotation angle is excessively large, the sweeping speed of the output shaft 131 is excessively high, and the teeth cannot be effectively cleaned.

Optionally, in some embodiments of the present application, the first angle and/or the second angle ranges from 6 degrees to 18 degrees.

In the embodiment of the present application, the first angle and/or the second angle can be controlled within the range of 6 degrees to 18 degrees, thus avoiding both the injury to the gum caused by the excessively large first and/or second angle and the problem of insufficient cleaning of the teeth caused by the excessively small first and/or second angle.

Optionally, in some embodiments of the present application, the first angle and/or the second angle ranges from 12 degrees to 15 degrees.

In the embodiment of the present application, the first angle and/or the second angle can be further controlled within the range of 12 degrees to 15 degrees, thus avoiding both the injury to the gum caused by the excessively large first and/or second angle and the problem of insufficient cleaning of the teeth caused by the excessively small first and/or second angle, and further improving the experience of the user.

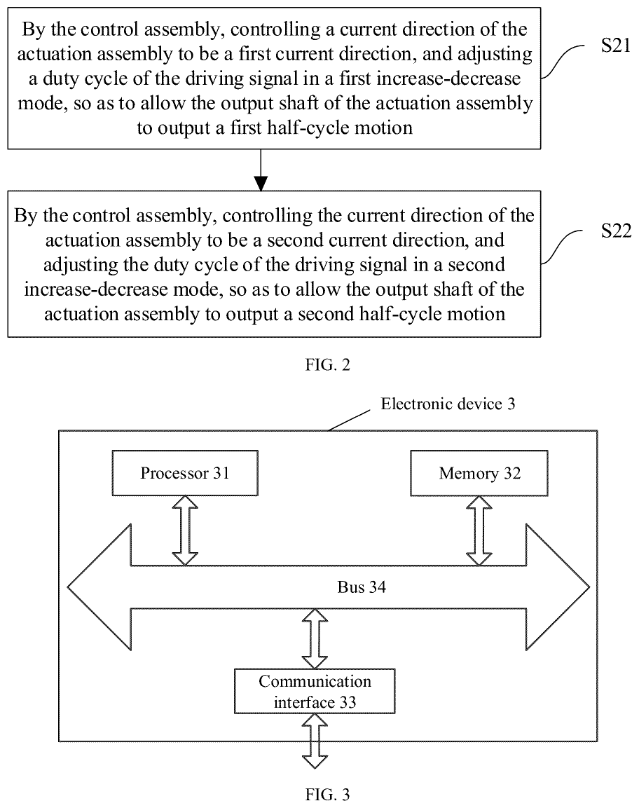

Based on the oral nursing device shown in FIG. 1, embodiments of the present application provide a control method of the oral nursing device, an execution subject of the method is the control assembly 14 of the oral nursing device, and as shown in FIG. 2, the method includes:
S21: by the control assembly 14, controlling a current direction of the actuation assembly 13 to be a first current direction, and adjusting a duty cycle of the driving signal in a first increase-decrease mode, so as to allow the output shaft 131 of the actuation assembly 13 to output a first half-cycle motion; and
S22: by the control assembly 14, controlling the current direction of the actuation assembly 13 to be a second current direction, and adjusting the duty cycle of the driving signal in a second increase-decrease mode, so as to allow the output shaft 131 of the actuation assembly 13 to output a second half-cycle motion,
wherein the first current direction is different from the second current direction, and the periodic motion includes the first half-cycle motion and the second half-cycle motion.

In the embodiment of the present application, the control assembly 14 can drive the output shaft 131 of the actuation assembly 13 to output a cleaning motion by outputting the driving signal, so as to drive the cleaning unit 111 to vibrate at a high speed, thereby cleaning teeth. Meanwhile, in one cleaning motion, the output shaft 131 rotates by a certain angle in a first direction or a second direction. Under the condition that the output shaft 131 outputs a plurality of cleaning motions, the cleaning unit 111 produces a sweeping effect, such that the action that a human hand swings a brush head to clean the teeth can be imitated to clean the oral cavity more thoroughly and deeply, thus improving a tooth cleaning effect.

Optionally, in some embodiments of the present application, the control assembly 14 periodically changes the current direction of the actuation assembly 13 between the first current direction and the second current direction, such that the output shaft 131 of the actuation assembly 13 periodically outputs the first half-cycle motion and the second half-cycle motion.

Optionally, in some embodiments of the present application, the adjusting a duty cycle of the driving signal in a first increase-decrease mode, so as to allow the output shaft 131 of the actuation assembly 13 to output a first half-cycle motion includes:
increasing the duty cycle of the pulse width modulation signal according to a preset increment value, and driving the output shaft 131 to output a plurality of cleaning motions, such that the output shaft 131 rotates by a first angle with a first axis as a rotation center line; and decreasing the duty cycle of the pulse width modulation signal according to the preset increment value, and driving the output shaft 131 to output a plurality of cleaning motions, such that the output shaft 131 rotates back to an initial position with the first axis as the rotation center line;
the cleaning motion includes a first motion and a second motion, and as the first motion, the output shaft 131 rotates by a first rotation angle along the first direction with the first axis as the rotation center line, and as the second motion, the output shaft 131 rotates by a second rotation angle along the second direction with the first axis as the rotation center line, the first direction and the second direction are opposite, and the first rotation angle is different from the second rotation angle.

Optionally, in some embodiments of the present application, when the first rotation angle is larger than the second rotation angle, the cleaning motion is a first cleaning motion; when the second rotation angle is larger than the first rotation angle, the cleaning motion is a second cleaning motion.

Optionally, in some embodiments of the present application, a rotation direction of the first half-cycle motion is the first direction; the increasing the duty cycle of the pulse width modulation signal according to a preset increment value, and driving the output shaft 131 to output a plurality of cleaning motions, such that the output shaft 131 rotates by a first angle with a first axis as a rotation center line includes: increasing the duty cycle of the pulse width modulation signal according to the preset increment value, and driving the output shaft 131 to output a plurality of first cleaning motions, such that the output shaft 131 rotates by the first angle with the first axis as the rotation center line;
the decreasing the duty cycle of the pulse width modulation signal according to the preset increment value, and driving the output shaft 131 to output a plurality of cleaning motions, such that the output shaft 131 rotates back to an initial position with the first axis as the rotation center line includes:
decreasing the duty cycle of the pulse width modulation signal according to the preset increment value, and driving the output shaft 131 to output a plurality of second cleaning motions, such that the output shaft 131 rotates back to the initial position with the first axis as the rotation center line.

Optionally, in some embodiments of the present application, the rotation direction of the first half-cycle motion is the second direction; the increasing the duty cycle of the pulse width modulation signal according to a preset increment value, and driving the output shaft 131 to output a plurality of cleaning motions, such that the output shaft 131 rotates by a first angle with a first axis as a rotation center line includes: increasing the duty cycle of the pulse width modulation signal according to the preset increment value, and driving the output shaft 131 to output a plurality of second cleaning motions, such that the output shaft 131 rotates by the first angle with the first axis as the rotation center line;
the decreasing the duty cycle of the pulse width modulation signal according to the preset increment value, and driving the output shaft 131 to output a plurality of cleaning motions, such that the output shaft 131 rotates back to an initial position with the first axis as the rotation center line includes:
decreasing the duty cycle of the pulse width modulation signal according to the preset increment value, and driving the output shaft 131 to output a plurality of first cleaning motions, such that the output shaft 131 rotates back to the initial position with the first axis as the rotation center line.

Optionally, in some embodiments of the present application, the frequency of the actuation assembly 13 is more than 100 Hz.

Optionally, in some embodiments of the present application, the frequency of the actuation assembly 13 ranges from 100 Hz to 300 Hz.

Optionally, in some embodiments of the present application, the frequency of the actuation assembly 13 is substantially constant.

Optionally, in some embodiments of the present application, the first rotation angle and/or the second rotation angle ranges from 0.1 degrees to 1.5 degrees.

Optionally, in some embodiments of the present application, the first rotation angle and/or the second rotation angle ranges from 0.3 degrees to 1.0 degree.

Optionally, in some embodiments of the present application, the first angle and/or the second angle ranges from 6 degrees to 18 degrees.

Optionally, in some embodiments of the present application, the first angle and/or the second angle ranges from 12 degrees to 15 degrees.

The control method of the oral nursing device according to the embodiment of the present application corresponds to the actions of the control assembly in the above embodiment, and implementation principles and technical effects thereof are similar and are not repeated herein.

In a third aspect, embodiments of the present application provide an electronic device, which can effectively improve a tooth cleaning effect.

As shown in FIG. 3, the electronic device according to the embodiment of the present application may include a processor 31 and a memory 32. The electronic device 3 may further include a communication interface 33 and a bus 34. The processor 31, the communication interface 33, and the memory 32 may be communicated with each other through the bus 34. The communication interface 33 may be configured for information transmission. The processor 31 may invoke logic instructions in the memory 32 to perform the control method of an oral nursing device according to the embodiment described above.

Furthermore, the logic instructions in the memory 32 may be implemented in the form of software functional units and stored in a computer-readable storage medium when sold or used as independent products.

As a computer-readable storage medium, the memory 32 may be configured to store software programs and computer-executable programs, such as program instructions/modules corresponding to the method according to the embodiment of the present application. By executing the program instructions/modules stored in the memory 32, the processor 31 executes functional applications and data processing, that is, implements the control method of an oral nursing device according to the above-described embodiment.

The memory 32 may include a program storage region and a data storage region, and the program storage region may store an operating system and an application required for at least one function; the data storage region may store data created according to the use of a terminal device, or the like. Furthermore, the memory 32 may include a high speed random access memory and may also include a non-volatile memory.

In a fourth aspect, embodiments of the present application further provide a computer-readable storage medium storing computer-executable instructions configured to perform the control method of an oral nursing device according to the above embodiments.

The storage medium described above may be a transitory computer-readable storage medium or a non-transitory computer-readable storage medium.

The above description and the drawings sufficiently illustrate the embodiments of the disclosure to enable those skilled in the art to practice them. Other embodiments may incorporate structural, logical, electrical, process, and other changes. The embodiments merely typify possible variations. Individual components and functions are optional unless explicitly required, and the sequence of operations may vary. Parts and features of some embodiments may be included in or substituted for parts and features of other embodiments. Moreover, the terms used in the present application are intended only to describe the embodiments and are not intended to limit the claims.

What is claimed is:

1. An oral nursing device, comprising:
a cleaning portion at least provided with a cleaning unit;
a grip portion connected with the cleaning portion;
an actuation assembly at least partially accommodated in the grip portion, the actuation assembly comprising an output shaft engaged with the cleaning portion; and
a control assembly generating a driving signal to drive the output shaft of the actuation assembly to output a cleaning motion and thus drive the cleaning unit,
wherein the cleaning motion comprises a first motion and a second motion, and as the first motion, the output shaft rotates by a first rotation angle along a first direction with a first axis as a rotation center line, and as the second motion, the output shaft rotates by a second rotation angle along a second direction with the first axis as the rotation center line, the first direction and the second direction are opposite, and the first rotation angle is different from the second rotation angle.

2. The device according to claim 1, wherein the control assembly further generates the driving signal to drive the output shaft of the actuation assembly to output a periodic motion;
the periodic motion comprises at least a first half-cycle motion and/or a second half-cycle motion, and
as the first half-cycle motion, the control assembly generates the driving signal to drive the output shaft to output one or more cleaning motions, such that the output shaft rotates by a first angle and then rotates back to an initial position with the first axis as the rotation center line;
as the second half-cycle motion, the control assembly generates the driving signal to drive the output shaft to output one or more cleaning motions, such that the output shaft rotates by a second angle and then rotates back to the initial position with the first axis as the rotation center line;
a direction of rotation of the output shaft by the first angle is different from a direction of rotation of the output shaft by the second angle.

3. The device according to claim 2, wherein the control assembly determines a current direction of the actuation assembly to determine whether the output shaft outputs the first half-cycle motion or the second half-cycle motion.

4. The device according to claim 2, wherein the control assembly periodically modifies the current direction of the actuation assembly to allow the output shaft to periodically switch output of the first half-cycle motion and the second half-cycle motion.

5. The device according to claim 2, wherein the driving signal is a pulse width modulation signal, and the control assembly increases and decreases a duty cycle of the pulse width modulation signal according to a preset increment value, so as to allow the output shaft to output the first half-cycle motion.

6. The device according to claim 5, wherein the control assembly increases the duty cycle of the pulse width modulation signal according to the preset increment value, and drives the output shaft to output a plurality of cleaning motions, such that the output shaft rotates by the first angle with the first axis as the rotation center line; the control assembly decreases the duty cycle of the pulse width modulation signal according to the preset increment value, and drives the output shaft to output a plurality of cleaning motions, such that the output shaft rotates back to the initial position with the first axis as the rotation central line.

7. The device according to claim 6, wherein a rotation direction of the first half-cycle motion is the first direction, and the control assembly increases the duty cycle of the pulse width modulation signal according to the preset increment value, and drives the actuation assembly to output a plurality of cleaning motions with the first rotation angle greater than the second rotation angle, such that the output shaft rotates by the first angle with the first axis as the rotation center line; the control assembly decreases the duty cycle of the pulse width modulation signal according to the preset increment value, and drives the actuation assembly to output a plurality of cleaning motions with the second rotation angle greater than the first rotation angle, such that the output shaft rotates back to the initial position with the first axis as the rotation center line.

8. The device according to claim 6, wherein the rotation direction of the first half-cycle motion is the second direction, and then, the control assembly increases the duty cycle of the pulse width modulation signal according to the preset increment value, and the second rotation angle is greater than the first rotation angle, such that the output shaft rotates by the first angle with the first axis as the rotation center line; the control assembly reduces the duty cycle of the pulse width modulation signal according to the preset increment value, and the first rotation angle is greater than the second rotation angle, such that the output shaft rotates back to the initial position with the first axis as the rotation center line.

9. The device according to claim 1, wherein the control assembly further drives the actuation assembly to output a periodic vibration with a different rotation direction and a same rotation angle.

10. The device according to claim 1, wherein the control assembly determines the first rotation angle and/or the second rotation angle according to user operations, sensed data and/or historical usage data.

11. The device according to claim 1, wherein the frequency of the actuation assembly is more than 100 Hz.

12. The device according to claim 1, wherein the frequency of the actuation assembly is substantially constant.

13. The device according to claim 1, wherein the first rotation angle and/or the second rotation angle ranges from 0.1 degrees to 1.5 degrees.

14. The device according to claim 2, wherein the first angle and/or the second angle ranges from 6 degrees to 18 degrees.

15. A control method of an oral nursing device, the oral nursing device comprising:
a cleaning portion at least provided with a cleaning unit;
a grip portion connected with the cleaning portion;
an actuation assembly at least partially accommodated in the grip portion, the actuation assembly comprising an output shaft engaged with the cleaning portion; and
a control assembly using a driving signal to drive the output shaft of the actuation assembly to output a periodic motion and thus drive the cleaning unit;
the control method of an oral nursing device comprising:
by the control assembly, controlling a current direction of the actuation assembly to be a first current direction, and adjusting a duty cycle of the driving signal in a first increase-decrease mode, so as to allow the output shaft of the actuation assembly to output a first half-cycle motion; and
by the control assembly, controlling the current direction of the actuation assembly to be a second current direction, and adjusting the duty cycle of the driving signal in a second increase-decrease mode, so as to allow the output shaft of the actuation assembly to output a second half-cycle motion,
wherein the first current direction is different from the second current direction, and the periodic motion comprises the first half-cycle motion and the second half-cycle motion.

16. The control method according to claim 15, wherein the control assembly periodically changes the current direction of the actuation assembly between the first current direction and the second current direction, such that the output shaft of the actuation assembly periodically outputs the first half-cycle motion and the second half-cycle motion.

17. The control method according to claim 15, wherein the adjusting a duty cycle of the driving signal in a first increase-decrease mode, so as to allow the output shaft of the actuation assembly to output a first half-cycle motion comprises:
increasing the duty cycle of the pulse width modulation signal according to a preset increment value, and driving the output shaft to output a plurality of cleaning motions, such that the output shaft rotates by a first angle with a first axis as a rotation center line; and decreasing the duty cycle of the pulse width modulation signal according to the preset increment value, and driving the output shaft to output a plurality of cleaning motions, such that the output shaft rotates back to an initial position with the first axis as the rotation center line;
the cleaning motion comprises a first motion and a second motion, and as the first motion, the output shaft rotates by a first rotation angle along a first direction with the first axis as the rotation center line, and as the second motion, the output shaft rotates by a second rotation angle along a second direction with the first axis as the rotation center line, the first direction and the second direction are opposite, and the first rotation angle is different from the second rotation angle.

18. The control method according to claim 17, wherein when the first rotation angle is larger than the second rotation angle, the cleaning motion is a first cleaning motion; when the second rotation angle is larger than the first rotation angle, the cleaning motion is a second cleaning motion.

19. The control method according to claim 18, wherein a rotation direction of the first half-cycle motion is the first direction; the increasing the duty cycle of the pulse width modulation signal according to a preset increment value, and driving the output shaft to output a plurality of cleaning motions, such that the output shaft rotates by a first angle with a first axis as a rotation center line comprises: increasing the duty cycle of the pulse width modulation signal according to the preset increment value, and driving the output shaft to output a plurality of first cleaning motions, such that the output shaft rotates by the first angle with the first axis as the rotation center line;
the decreasing the duty cycle of the pulse width modulation signal according to the preset increment value, and driving the output shaft to output a plurality of cleaning motions, such that the output shaft rotates back to an initial position with the first axis as the rotation center line comprises:
decreasing the duty cycle of the pulse width modulation signal according to the preset increment value, and driving the output shaft to output a plurality of second cleaning motions, such that the output shaft rotates back to the initial position with the first axis as the rotation center line.

20. The control method according to claim 18, wherein the rotation direction of the first half-cycle motion is the second direction; the increasing the duty cycle of the pulse width modulation signal according to a preset increment value, and driving the output shaft to output a plurality of cleaning motions, such that the output shaft rotates by a first angle with a first axis as a rotation center line comprises: increasing the duty cycle of the pulse width modulation signal according to the preset increment value, and driving the output shaft to output a plurality of second cleaning motions, such that the output shaft rotates by the first angle with the first axis as the rotation center line;
the decreasing the duty cycle of the pulse width modulation signal according to the preset increment value, and driving the output shaft to output a plurality of cleaning motions, such that the output shaft rotates back to an initial position with the first axis as the rotation center line comprises:
decreasing the duty cycle of the pulse width modulation signal according to the preset increment value, and driving the output shaft to output a plurality of first cleaning motions, such that the output shaft rotates back to the initial position with the first axis as the rotation center line.
